(19) United States
(12) Patent Application Publication
(10) Pub. No.: US 2007/0253195 A1
(43) Pub. Date: Nov. 1, 2007

(54) Flashlight

(76) Inventor: Dan L. Dietz, Houston, TX (US)

Correspondence Address: TUMEY, L.L.P., P.O. BOX 22188, HOUSTON, TX, 77227-2188, US

(21) Appl. No.: 11/742,064

(22) Filed: Apr. 30, 2007

Related U.S. Application Data
(63) Continuation-in-part of application No. 10/908,108, filed on Apr. 27, 2005.

(51) Int. Cl. F21L 4/04

(52) U.S. Cl. 362/203; 362/202

(57) ABSTRACT

A flashlight and method for coupling the flashlight are disclosed. In an embodiment, the flashlight comprise a magnet, a battery, and an insulator. The flashlight further includes a housing in which the magnet, the battery, and the insulator are disposed. In addition, the flashlight includes a switch and a light. Moreover, the flashlight includes an electrical circuit between the battery, the switch, the light, and the magnet. The insulator prevents conduction of electricity from the electrical circuit to the housing.

### CROSS-REFERENCE TO RELATED APPLICATIONS

This application is a continuation-in-part application of U.S. application Ser. No. 10/908,108 filed on Apr. 27, 2005, which is incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

This invention relates to the field of flashlights and more specifically to the field of magnetic flashlights.

2. Background of the Invention

A typical flashlight includes an incandescent light bulb, batteries, and a switch. Such components are disposed in a housing that provides the electrical circuit to activate the light bulb. Flashlights are used in a variety of applications. Drawbacks to conventional flashlight designs include design inefficiencies such as engagement of the flashlights with other objects.

Consequently, there is a need for an improved flashlight design. Further needs include a flashlight with an improved ability to engage with other objects.

### BRIEF SUMMARY OF SOME OF THE PREFERRED EMBODIMENTS

These and other needs in the art are addressed in one embodiment by a flashlight. The flashlight includes a magnet, a battery, and an insulator. The flashlight also includes a housing in which the magnet, the battery, and the insulator are disposed. In addition, the flashlight includes a switch and a light. The flashlight further includes an electrical circuit between the battery, the switch, the light, and the magnet. The insulator prevents conduction of electricity from the electrical circuit to the housing.

In an embodiment, these and other needs in the art are addressed by a method of forming a magnetically coupled item. The method comprises providing a flashlight having a magnet, a battery, an insulator, and a housing. The magnet, the battery, and the insulator are disposed within the housing. In addition, the flashlight includes a switch and a light. The flashlight further includes an electrical circuit between the battery, the switch, the light, and the magnet. The insulator prevents conduction of electricity from the electrical circuit to the housing. The method further includes providing another item. In addition, the method includes magnetically coupling the flashlight to the another item to form the magnetically coupled item.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a flashlight with a magnet and an insulator;

FIG. 2A illustrates a flashlight with a magnet having a conductive coating;

FIG. 2B illustrates a flashlight with a magnet having a conductive member;

FIG. 2C illustrates a flashlight with a solid conductive magnet;

FIG. 3 illustrates an embodiment of a switch having threads;

FIG. 4 illustrates a flashlight having a flexible member;

FIG. 5 illustrates a flashlight having a flexible member;

FIG. 6 illustrates a magnetic field exerted by a magnet disposed in a flashlight;

FIG. 7 illustrates a flashlight having a clip;

FIG. 8 illustrates a clip arm of a clip;

FIG. 9 illustrates a guard disposed on a clip arm;

FIG. 10 illustrates the south pole of a clip magnet proximate to a north pole of the magnet in the flashlight; and

FIG. 11 illustrates a side view of a flashlight having perforations.

### DETAILED DESCRIPTION OF THE PREFERRED EMBODIMENTS

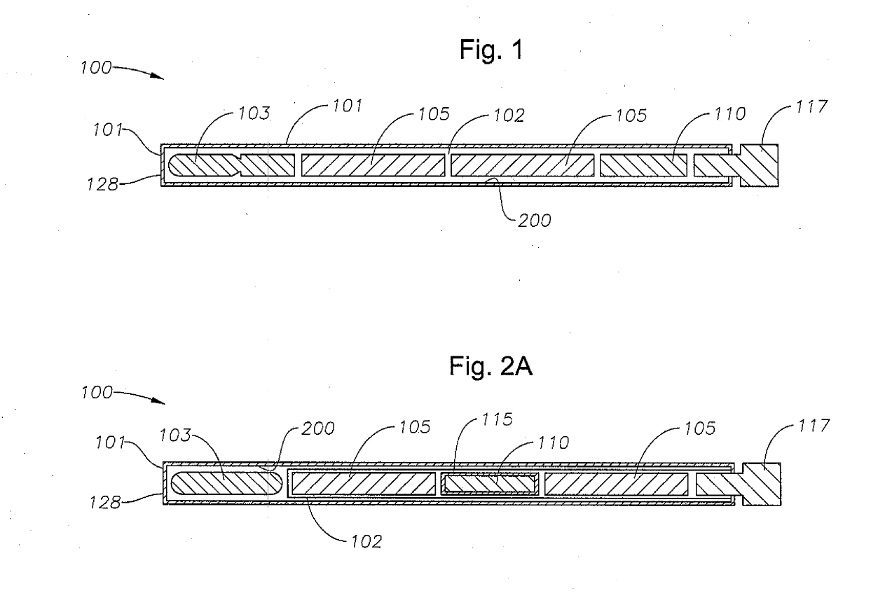

FIG. 1 illustrates flashlight 100 having a housing 101. Housing 101 may be composed of any material such as metal, plastic, and the like. Battery compartment 102 is disposed within housing 101. Flashlight 100 further includes light 103, one or more batteries 105, switch 117, magnet 110, lens 128, and insulator 200. As shown in FIG. 1, magnet 110 may be disposed within housing 101. In an alternative embodiment (not illustrated), magnet 110 is disposed on the exterior of housing 101. Battery 105 may include any battery suitable for use with a flashlight. In addition, light 103 may include any light suitable for use with a flashlight. Without limitation, an example of a suitable light includes a light-emitting diode (LED). When one or more batteries 105 are positioned in battery compartment 102, an electrical circuit is formed between the one or more batteries 105, switch 117, and light 103. Magnet 110 may or may not be conductive. It is to be understood that conductive refers to the ability to conduct or transmit electricity. In an embodiment in which magnet 110 is conductive, when the one or more batteries 105 are positioned in battery compartment 102, the electrical circuit is formed between the one or more batteries 105, switch 117, light 103, and magnet 110. Flashlight 100 may include any electrical connectors suitable to complete the electrical circuit and electrically connect the one or more batteries 105, switch 117, light 103 and optionally magnet 110. Lens 128 may include any lens suitable for use with a flashlight.

Insulator 200 may include any non-electrically conductive material. Without limitation, examples of such materials include silicon dioxide, rubber, and plastic. In an embodiment, insulator 200 comprises plastic. Insulator 200 may be of a suitable thickness and suitably positioned in housing 101 to prevent conduction of electricity from the electrical circuit to housing 101. For instance, insulator 200 is disposed between the components of the electrical circuit (e.g., light 103, battery 105, magnet 110, and switch 117 or light 103, battery 105, and switch 117) and housing 101, as shown in FIG. 1. Insulator 200 may be disposed between the components of the electrical circuit and housing 101 by any suitable means. For instance, insulator 200 may be a coating on the interior of housing 101. In other embodiments, insulator 200 has a solid shape and is positioned between the electrical circuit components and housing 101, with insulator 200 having an outside diameter less than the inside diameter of housing 101. For instance, insulator 200 may have a cylindrical shape with an outside diameter less than the inside diameter of housing 101. In alternative embodiments (not illustrated), flashlight 100 does not include insulator 200. Without being limited by theory, such alternative embodiments may include embodiments in which housing 101 is composed of a non-electrically conductive material.

In an alternative embodiment, magnet 110 is not conductive. In such an alternative embodiment, the electrical circuit may include the one or more batteries 105, switch 117, and light 103. In addition, the electrical circuit may be completed around magnet 110. In another alternative embodiment (not illustrated), flashlight 100 does not include lens 128.

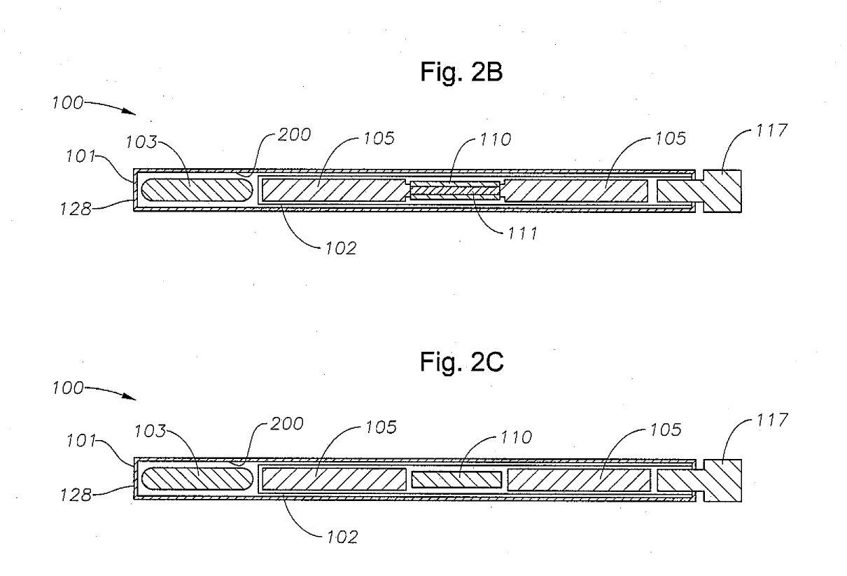

FIGS. 2A-2C illustrate embodiments in which magnet 110 is conductive. FIG. 2A illustrates an embodiment in which magnet 110 has a conductive coating 115. Conductive coating 115 may comprise any electrically conductive material suitable for use with magnet 110 and flashlight 100. In an embodiment, conductive coating 115 coats substantially all of the exterior of magnet 110. In other embodiments, conductive coating 115 partially coats the exterior of magnet 110 to provide a sufficient electrical pathway to complete the electrical circuit.

FIG. 2B illustrates an embodiment in which magnet 110 has a conductive member 111. Conductive member 111 may traverse any section of magnet 110. In some embodiments, conductive member 111 may be substantially positioned in the center of magnet 110 as shown in FIG. 2B. Without being limited by theory, conductive member 111 in such an embodiment may engage the typically centered electrical contacts of batteries 105. Conductive member 111 may comprise any electrically conductive material suitable for use with magnet 110 and flashlight 100.

FIG. 2C illustrates an embodiment in which magnet 110 is a solid conductive magnet. In such an embodiment, magnet 110 is composed of an electrically conductive material.

It is to be understood that magnet 110 may be disposed at any location in housing 101 or alternatively on the exterior of housing 101. For instance, magnet 110 may be disposed in housing 101 between batteries 105, between switch 117 and battery 105, and/or between light 103 and battery 105. In addition, some embodiments include more than one magnet 110. In such embodiments, the additional magnet or magnets may also be positioned at any suitable location.

Without limitation, an example of a suitable magnet 110 and position includes an annularly shaped magnet 110 (i.e., a ring magnet) disposed in the annular space between battery 105 and housing 101. Such a magnet 110 may or may not be part of the electrical circuit.

In an embodiment, operation of flashlight 100 as illustrated in FIGS. 1 and 2A-2C includes operating of switch 117 to open or close the electrical circuit between batteries 105, switch 117, light 103 and magnet 110 (e.g., when included in the circuit), to turn light 103 off or on.

In some embodiments, magnet 110 is not a magnet but is instead comprised of a non-magnetic magnetically coupling material, for example a ferrous material.

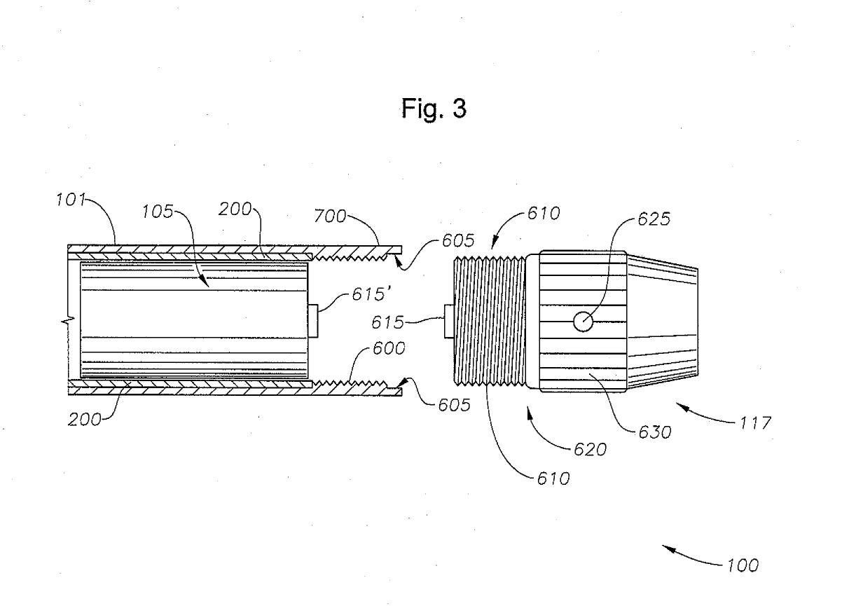

It is to be understood that switch 117 may include any switch suitable for use with a flashlight and for forming the electrical circuit with battery 105, light 103 and optionally magnet 110. FIG. 3 illustrates an embodiment in which switch 117 is screwed into housing 101 (e.g., internal threads 600 engage external threads 610). It is to be understood that housing 101 is shown in a cross sectional view for illustration purposes. As shown, housing 101 also includes insulator 200, internal threads 600, and seal lip 605. It is to be further understood that internal threads 600 include any threads suitable for receiving external threads. Internal threads 600 are disposed on the interior of housing 101 between insulator 200 and seal lip 605 on the longitudinal end of flashlight 100 distal to light 103. Seal lip 605 has a suitable depth for providing a support area for switch 117 when switch 117 is inserted into housing 101 but before switch 117 is screwed into housing 101 and external threads 610 engage internal threads 600. Switch 117 includes external threads 610, electrical connector 615, seal 620, opening 625, and grips 630. It is to be understood that external threads 610 include any external threads suitable for insertion into internal threads. In addition, it is to be understood that electrical connector 615 includes any suitable connectors for connecting components of an electrical circuit. As shown, switch 117 includes one seal 620. In alternative embodiments (not illustrated), switch 117 includes no seal or more than one seal 620. Seal 620 may include any mechanical seal suitable for use with a flashlight. In addition, seal 620 may have any configuration suitable for use with flashlight 100. For instance, as illustrated in FIG. 3, seal 620 is an o-ring. In an embodiment, seal 620 comprises an o-ring when housing 101 has a cylindrical shape. In other embodiments, seal 620 has other configurations such as an x-ring, a quad ring, or the like. In an embodiment, seal 620 may be disposed in a groove (not illustrated) in the surface of switch 117. Opening 625 provides a passage through switch 117. Without being limited by theory, opening 625 may be used to store flashlight 100. For instance, a hook or string may be passed through opening 625 to store flashlight 100. In alternative embodiments (not illustrated), switch 625 has no opening 625 or more than one opening 625. Grips 630 include any material and/or configuration that may improve contact with a provider of force for rotating switch 117 or holding switch 117 without rotation upon rotation of housing 101 (i.e., a user's hand). For instance, grips 630 may include ridges, depressions, and/or adhesive materials. In an alternative embodiment (not illustrated), switch 117 has no grips 630.

In operation, as shown in FIG. 3, switch 117 may be placed in housing 101 with external threads 610 disposed upon seal lip 605. To secure switch 117 in housing 101, switch 117 may be screwed into housing 101 with external threads 610 engaging internal threads 605. To activate light 103 (not illustrated) and emit light, switch 117 may be screwed into housing 101 until electrical connector 615 is in contact with electrical connector 615′ of battery 105 (or alternatively in contact with magnet 110 (not illustrated)). The electrical circuit in flashlight 100 is then closed and complete, and light 103 is turned on. To de-activate light 103 (e.g., break the electrical circuit and turn the light off), switch 117 is unscrewed until electrical connector 615 is not in contact with electrical connector 615′ (or alternatively not in contact with magnet 110), and the electrical circuit is then broken. When switch 117 is screwed into housing 101 and electrical connector 615 is in sufficient contact to complete the electrical circuit of flashlight 100, seal 620 is disposed within seal lip 605 and substantially seals housing 101.

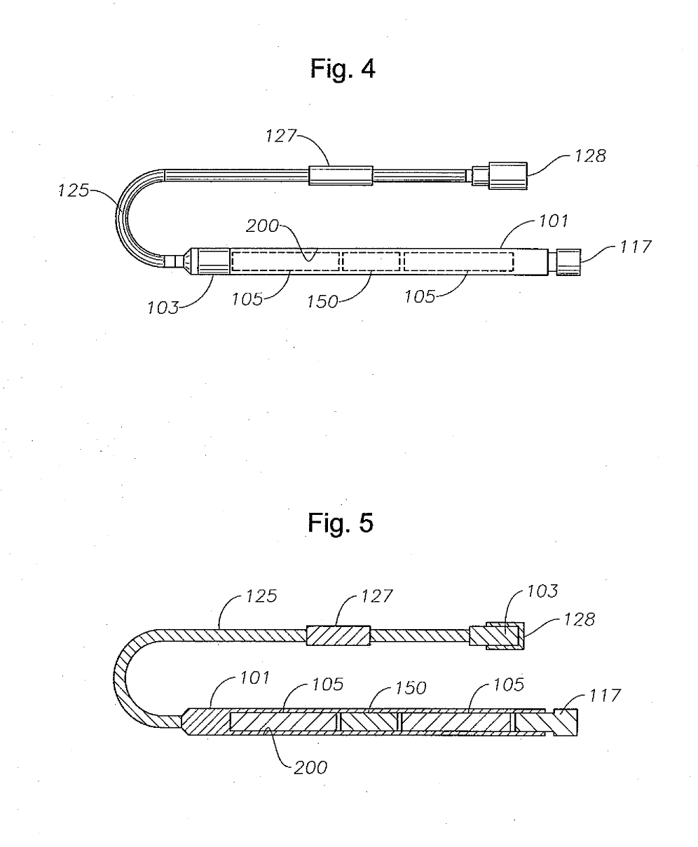

FIG. 4 illustrates an embodiment in which flashlight 100 is further provided with a light conducting flexible member 125 attached to housing 101. In such an embodiment, light emitted from light 103 is directed through flexible member 125 and out through lens 128. Flashlight 100 further includes a second magnetically coupling member 127. Second magnetically coupling member 127 is engageable to magnetically coupling member 150. In an embodiment, second magnetically coupling member 127 is composed of a magnetic material, and magnetically coupling member 150 is composed of a non-magnetic material (e.g., such as a ferrous material). In another embodiment, second magnetically coupling member 127 is composed of a non-magnetic material, and magnetically coupling member 150 is composed of a magnetic material. In an embodiment, coupling of second magnetically coupling member 127 and magnetically coupling member 150 to each other may position lens 128 to direct light in a desired manner. In other embodiments, coupling of second magnetically coupling member 127 and magnetically coupling member 150 to each other may attach flashlight 100 to an object such as a shirt pocket. For instance, by positioning the shirt pocket material between the magnetically engaged magnetically coupling member 150 and second magnetically coupling member 127, flashlight 100 may be attached to the shirt pocket material.

FIG. 5 illustrates an embodiment in which light 103 is positioned at the end of flexible member 125. In such an embodiment, second magnetically coupling member 127 may engage magnetically coupling member 150.

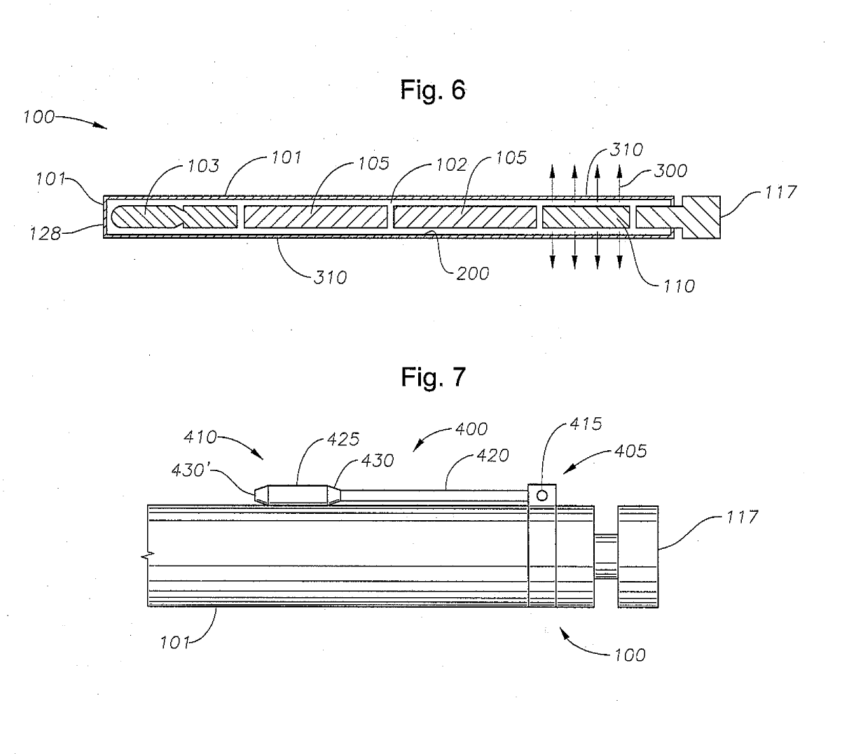

In an embodiment, flashlight 100 may be magnetically coupled to another item such as a writing instrument (e.g., pen) or a utility clip. In such an embodiment, at least one of flashlight 100 or the another item includes a magnet, with the other including a magnetically attractive material. For instance, magnet 110 is a magnet or a magnetically attractive material, and the other item includes a magnet or a magnetically attractive material. Magnetically attractive material may include any material that attracts a magnetic force. Without limitation, examples of suitable magnetically attractive materials include a magnet, iron, steel, and the like. It is to be understood that in such embodiments magnet 110 may exert a magnetic field. Without being limited by theory, the magnetic field may couple flashlight 100 to the another item. FIG. 6 illustrates an embodiment of flashlight 100 with magnet 110 exerting a magnetic field 300. Magnetic field 300 may be exerted through sides 310 of flashlight 100 to couple another item to one or both of sides 310. As a non-limiting example, flashlight 100 may be magnetically coupled to the writing instrument disclosed in U.S. Patent Application Publication No. 2006-0233591 or the utility clip disclosed in U.S. Patent Application Publication No. 2006-0239754, which are incorporated by reference herein in their entirety.

FIG. 7 illustrates an embodiment in which flashlight 100 further includes clip 400. Clip 400 includes pivot end 405 and engagement end 410. In addition, clip 400 comprises clip arm 420 and clip magnet 425. Clip 400 may be secured to flashlight 100 by any suitable means. In an embodiment as shown in FIG. 7, pivot end 405 may be attached to housing 101 by press fit. Clip 400 may be sufficiently attached to housing 101 to prevent longitudinal movement of pivot end 405 in relation to housing 101, or alternatively clip 400 may be longitudinally slidable along housing 101. Clip 400 is pivotally connected to flashlight 100 at pivot end 405. Pivot end 405 may have any design suitable for providing the pivotal connection. In an embodiment as shown in FIG. 7, pivot end 405 is pivotally connected to housing 101 by pin 415, which is inserted through pivot end 405 and clip arm 420, Clip magnet 425 may be attached to engagement end 410 by any suitable means. For instance, without limitation, clip magnet 425 may be glued, welded, clamped, and/or slidably engaged to engagement end 410. In the embodiment shown in FIG. 7, guards 430 and 430′ substantially prevent longitudinal movement of clip magnet 425 in relation to clip arm 420.

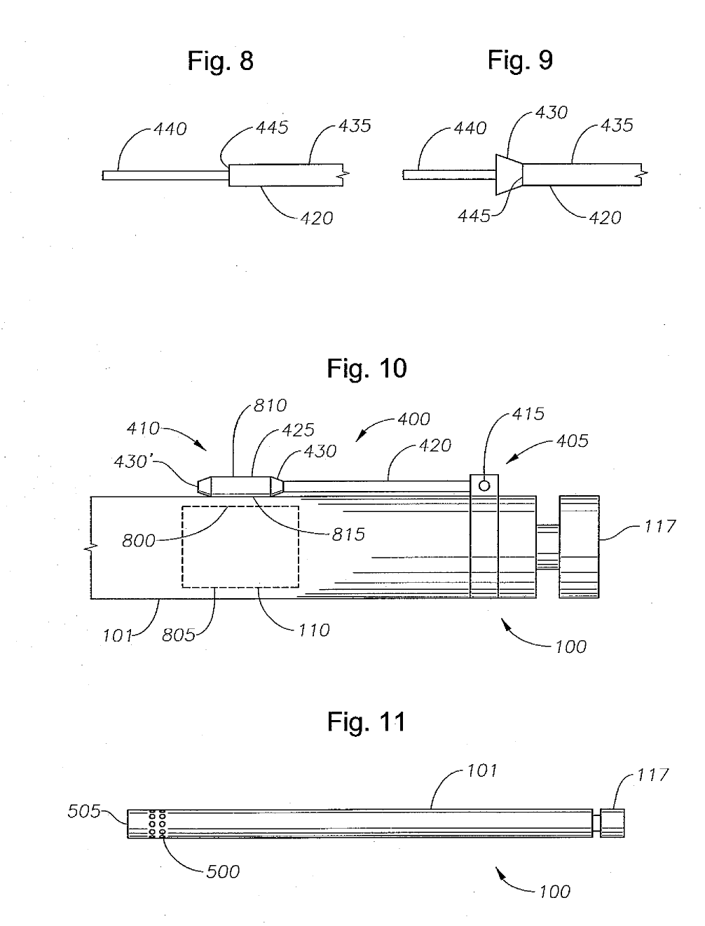

FIG. 8 illustrates an embodiment of clip arm 420. As shown, clip arm 420 has clip arm body 435 with an attachment end 440 having a diameter less than the diameter of clip arm body 435. The intersection of the reduced diameter attachment end 440 and clip arm body 435 provides stop 445. To attach clip magnet 425 to clip 400, clip magnet 425 and guards 430 are slidably engaged with attachment end 440. For illustration purposes, FIG. 9 shows guard 430 disposed after it has been engaged with attachment end 440. For instance, guard 430 is slidably engaged with attachment end 440 until guard 430 is in contact with stop 445. Upon such contact, further longitudinal movement of guard 430 in the direction of clip arm body 435 is prevented. It is to be understood that guard 430 has an opening through its interior that has a diameter larger than the diameter of attachment end 440 and smaller than the diameter of clip arm body 435. Clip magnet 425 may then be slidably engaged with attachment end 440 until further longitudinal movement of clip magnet 425 in the direction of clip arm body 435 is prevented by guard 430 and stop 445. It is to be understood that clip magnet 425 may also have an opening with a diameter larger than the diameter of attachment end 440. As shown in FIG. 7, another guard 430′ may then be engaged with attachment end 440 to substantially prevent longitudinal movement of clip magnet 425 along attachment end 440 in the direction away from clip arm body 435. Longitudinal movement of such another guard 430′ away from clip arm body 435 may be prevented by any suitable method such as by gluing such another guard 430′ to attachment end 440 or plugging the outer portion of the opening. It is to be understood that in alternative embodiments, clip 400 may have one guard 430′ and not guard 430. In another alternative embodiment, clip 400 may have more than one guard 430 and/or more than one guard 430′. For instance, in an embodiment (not illustrated) in which clip 400 has guard 430′ and not guard 430, clip magnet 425 is slidably engaged with attachment end 440 until further longitudinal movement of clip magnet 425 in the direction of clip arm body 435 is prevented by stop 445. Guard 430′ may then be slidably engaged with engagement end 440 until in contact with clip magnet 425. Guards 430 and 430′ may be composed of any suitable material such as rubber or metal. In an embodiment, guards 430 and 430′ are rubber.

It is to be understood that FIG. 7 illustrates clip 400 pivoted to a closed position. In such a closed position, clip magnet 425 engages housing 101. It is to be further understood that in such an embodiment housing 101 includes a magnetically attractive material. In some embodiments, flashlight 100 may be attached to an object such as a shirt pocket. In such embodiments, material of the object (e.g., shirt pocket) may be placed in a position between clip 400 and housing 101. Clip 400 pivots from an open position to a closed position (closed position shown in FIG. 7) to allow the material to be placed in such a position. Magnetic attraction of clip magnet 425 to housing 101 (and/or magnet 110) secures flashlight 100 to the material of the object.

FIG. 10 illustrates the position of magnet 110 in dashed form for illustration purposes to show its position. In an embodiment, magnet 110 has north pole 800 and south pole 805, and clip magnet 425 has clip magnet north pole 810 and clip magnet south pole 815. Magnet 110 is rotatable about its longitudinal axis within housing 101. In such an embodiment, clip magnet 425 is not rotatable about its longitudinal axis but has instead been attached to clip 400 with clip magnet north pole 810 distal to flashlight 100 and clip magnet south pole 815 proximate to flashlight 100. In such an embodiment, when clip 400 is in the closed position as shown in FIG. 10, the magnetic attraction of clip magnet south pole 815 attracts north pole 800, and magnet 110 rotates about its longitudinal axis until north pole 800 is proximate to clip magnet south pole 815. Therefore, north pole 800 is distal to the body of the individual, for instance when flashlight 100 is placed in a pocket of the individual and secured to the pocket by clip 400. Without being limited by theory, placing north pole 800 distal to the individual's body may prevent detrimental health issues to the individual that may be related to magnetic fields. For example, without being limited by theory, placing north pole 800 proximate to the individual's body may restrict blood flow in vessels exposed to the magnetic field exerted by north pole 800, which may be a detrimental health effect. Such restriction may not occur with south pole 805 proximate to the body. In alternative embodiments, magnet 110 is not longitudinally rotatable but is instead fixed in position within housing 101, with north pole 800 proximate to clip magnet south pole 815.

FIG. 11 illustrates an embodiment in which flashlight 100 further comprises perforations 500. In an embodiment, perforations 500 are positioned about the circumference of housing 101. Perforations 500 may be positioned at any location on housing 101 from about end 505 to light 103 (not illustrated). Without being limited by theory, perforations 500 allow light from light 103 to pass through housing 101, which may enhance the light emitted from light 103. Flashlight 100 may have any desirable number of perforations 500.

Although the present invention and its advantages have been described in detail, it should be understood that various changes, substitutions and alterations may be made herein without departing from the spirit and scope of the invention as defined by the appended claims.

What is claimed is:

1. A flashlight, comprising:
a magnet;
a battery;
an insulator;
a housing, wherein the magnet, the battery, and the insulator are disposed within the housing;
a switch;
a light; and
an electrical circuit between the battery, the switch, the light, and the magnet, and wherein the insulator prevents conduction of electricity from the electrical circuit to the housing.

2. The flashlight of claim 1, wherein the magnet is disposed between the battery and the switch.

3. The flashlight of claim 1, wherein the magnet is disposed between the battery and the light.

4. The flashlight of claim 1, wherein the flashlight comprises a second battery, and wherein the magnet is disposed between the battery and the second battery.

5. The flashlight of claim 1, further comprising a clip pivotally attached to the housing, and wherein the clip comprises a clip magnet.

6. The flashlight of claim 5, wherein the clip comprises a guard.

7. The flashlight of claim 5, wherein the clip comprises a stop.

8. The flashlight of claim 5, wherein the clip comprises a clip arm body and an attachment end, wherein the clip magnet is disposed on the attachment end.

9. The flashlight of claim 8, wherein the attachment end comprises a diameter less than a diameter of the clip arm body.

10. The flashlight of claim 5, wherein the clip magnet has a south pole, and wherein the magnet has a north pole, and farther wherein the north pole of the magnet is proximate to the south pole of the clip magnet.

11. The flashlight of claim 1, wherein the insulator comprises a non-electrically conductive material.

12. The flashlight of claim 1, wherein the housing comprises a plurality of perforations, and wherein light emitted from the light passes through the plurality of perforations.

13. The flashlight of claim 1, wherein the housing comprises internal threads, and wherein the switch comprises external threads.

14. The flashlight of claim 13, wherein the external threads engage the internal threads as the housing, the switch, or both are rotated.

15. The flashlight of claim 14, wherein the external threads engage the internal threads to suitably position the switch and complete the electrical circuit.

16. The flashlight of claim 14, wherein at least a portion of the external threads are disengaged from the internal threads to a position at which the electrical circuit is not complete.

17. The flashlight of claim 1, wherein the switch comprises a seal.

18. The flashlight of claim 17, wherein the housing comprises a seal lip, and wherein the seal is disposed within the seal lip.

19. A method of forming a magnetically coupled item, comprising:
(A) providing a flashlight comprising: a magnet; a battery; an insulator; a housing, wherein the magnet, the battery, and the insulator are disposed within the housing; a switch; a light; and an electrical circuit between the battery, the switch, the light, and the magnet, and wherein the insulator prevents conduction of electricity from the electrical circuit to the housing;
(B) providing another item; and
(C) magnetically coupling the flashlight to the another item to form the magnetically coupled item.

20. The method of claim 19, wherein the magnetically coupling farther comprises providing a magnetic field exerted by the magnet through the housing coupling the flashlight to the another item.
